(19) United States
(12) Patent Application Publication
(10) Pub. No.: US 2021/0064994 A1
(43) Pub. Date: Mar. 4, 2021

(54) MACHINE LEARNING DEVICE AND MACHINE LEARNING METHOD

(71) Applicant: HITACHI, LTD., Tokyo (JP)

(72) Inventor: Tatsuya TOMARU, Tokyo (JP)

(73) Assignee: HITACHI, LTD., Tokyo (JP)

(21) Appl. No.: 16/922,395

(22) Filed: Jul. 7, 2020

(30) Foreign Application Priority Data
Aug. 30, 2019 (JP) 2019-158104

(51) Int. Cl. G06N 3/08; G06N 3/063; G06F 7/544

(52) U.S. Cl. CPC G06N 3/08; G06F 7/544; G06N 3/063

(57) ABSTRACT

A machine learning device includes a general arithmetic device that calculates data, and a reservoir arithmetic device including an input unit, an output unit, and one or more nodes. The reservoir arithmetic device performs a certain calculation on data and performs calculation in response to an input value input through an input unit using the dynamics of the nodes. Each node i outputs a measurement outcome zᵢ(tₖ) at a time point tₖ. The general arithmetic device calculates y(tₖ)=Σᵢzᵢ(tₖ)wᵢ. In the calculation of y(tₖ), in addition to zᵢ(tₖ) at the time point zᵢ(tₖ), the term zᵢ(t_{k′}) at a time point t_{k′} (t_{k′}≠tₖ) is included. Thus, the calculation of y(tₖ) is performed by redundantly using zᵢ(tₖ) at different time points, with the range of sum with respect to the subscript i being i=1, . . . qn, where q is redundancy.

### BACKGROUND OF THE INVENTION

### 1. Field of the Invention

The present invention relates to a machine learning device and a machine learning method.

### 2. Description of the Related Art

Machine learning and artificial intelligence, which have been attracting high expectations recently, rely on deep learning as their core technology. Meanwhile, reservoir computing has also met with remarkable progress recently. These techniques are not so different from each other in terms of configuration only, but are different from each other in the learning process. Specifically, deep learning involves learning of all coefficients for calculation performed at each node, whereas reservoir computing involves learning of only coefficients related to output, with coefficients at each node fixed. In other words, the coefficients are learned over multiple layers in deep learning, but are learned only in a single layer in reservoir computing. These are the fundamental difference between these two methods in the configuration, and the difference characterizes each method. In deep learning, the coefficients of all nodes are learned. This results in the learning generally taking a long period of time, but also results in high calculation versatility. In contrast, reservoir computing involves the learning performed with the output layer only. Thus, compared with deep learning, shorter learning time can be achieved, but with the coefficients fixed at the nodes except for the output layer, the versatility is compromised. Still, with reservoir computing, learning is not required for layers other than the output layer, meaning that the versatility of the calculation unit is not required in the first place. Thus, while deep learning requires a calculator with relatively high versatility as a precondition, reservoir computing does not require the versatility of the calculation unit as a precondition. In view of this, active researches for using physical systems such as a spin system and a quantum system in reservoir computing have recently been conducted.

For example, WO2017/131081 discloses a quantum information processing system where reservoir computing is applied to a quantum system. WO2017/131081 discloses a “technique of a system including a quantum system including multiple qubits interacting with each other, in which a quantum reservoir includes multiple virtual nodes that hold signals from the respective qubits at each time points dividing a certain time interval into multiple intervals, a weight for determining a linear weight in a linear coupling between the multiple virtual nodes is determined, and an output signal is read that is obtained from quantum superimposition of the states at the virtual node and is linearly combined using the linear weight determined.”

Gouhei Tanaka, Toshiyuki Yamane, Jean Benoit He'roux, Ryosho Nakane, Naoki Kanazawa, Seiji Takeda, Hidetoshi Numata, Daiju Nakano, and Akira Hirose, “Recent Advances in Physical Reservoir Computing: A Review” arXiv: 1808.04962v2. discloses an example where reservoir computing is applied to a spin system, as one example of application of reservoir computing to a physical system (6. Spintronic RC).

### SUMMARY OF THE INVENTION

When a physical system is applied to a machine learning device, the controllability is insufficient but the degree of freedom of the system is high. The latter feature can offer rich dynamics (dynamic characteristics) required in machine learning. In particular, in quantum systems, physical quantities time-evolve in accordance with an equation different from that in classical systems, and thus the quantum systems can achieve dynamics unachievable in the classical systems. The disadvantage of insufficient controllability has been a problem for the application of the physical systems to machine learning devices; however as described above, this will no longer be a case if the concept of reservoir computing is used.

For the above reasons, the physical systems have become usable as machine learning devices. However, actual applications of physical systems to calculation units encounter many hardware limitations, and thus there are cases that cannot fully exploit the dynamics that are supposed to be provided with the physical systems, owing to reasons such as difficulty in measuring output values. This is particularly the case with a quantum system. Thus, to improve the effectiveness of the physical system in computing, a solution is required that enables us to draw out the dynamics of the physical system even when the number of measurement times is small. However, the above prior art does not consider this point, i.e., enabling us to sufficiently draw out the dynamics of the physical system even when the number of measurement times is small.

In view of the above, an object of the present invention is to provide a machine learning device capable of sufficiently drawing out the dynamics in a machine learning unit with a small number of measurement times.

A machine learning device according to the present invention preferably includes:
a general arithmetic device that calculates data;
a machine learning arithmetic device that performs certain calculation on the data;
a storage device that stores the data; and
a control device that controls the exchange of the data between the storage device and the general arithmetic device and between the storage device and the machine learning arithmetic device, wherein
the machine learning arithmetic device includes:
   at least one node;
   an input unit; and
   an output unit,
the machine learning arithmetic device performs calculation in response to an input value input through the input unit by utilizing the dynamics of the nodes and outputs a result of the calculation as a measurement outcome from the output unit, and
the general arithmetic device then redundantly uses each measurement outcome as a variable in the terms of a linear sum and outputs a result of the calculation.

With the present invention, a machine learning device capable of sufficiently exploiting the dynamics in a machine learning unit with a small number of measurement times can be provided.

### BRIEF DESCRIPTION OF THE DRAWINGS

FIG. 1 is a configuration diagram of a machine learning device according to a first embodiment;

FIGS. 2A and 2B respectively show a diagram illustrating training and inference in the machine learning device;

FIGS. 3A and 3B each show a diagram illustrating how an output is calculated from measurement outcomes at nodes;

FIG. 4 is a diagram illustrating how to process the matrix such that its elements are the measurement outcomes at nodes at respective time;

FIG. 5 is a configuration diagram of a machine learning device according to a second embodiment;

FIG. 6 is a diagram illustrating a task to be given to a machine learning device according to a fourth embodiment;

FIG. 7 is a diagram plotting the measurement outcomes at each node with respect to time;

FIGS. 8A and 8B each show a diagram showing examples of inference output obtained after training, comparing the case where an output value (measurement outcome) from a reservoir arithmetic device is used only once with the case where the output value (measurement outcome) is used multiple times;

FIG. 9 is a configuration diagram of a machine learning device according to a fifth embodiment; and

FIG. 10 is a diagram showing an application model of a machine learning device according to a sixth embodiment.

### DESCRIPTION OF THE PREFERRED EMBODIMENTS

Hereinafter, embodiments of the present invention will be described with reference to the drawings. The following description and the drawings are examples for describing the present invention, and they might be partly omitted and simplified to some extent as appropriate for the sake of clarification of the description. The present invention can be implemented in other various embodiments. Unless specified, each component may be provided singly or in plurality.

For the sake of understanding of the invention, the positions, sizes, shapes, ranges, and the like of the components shown in the drawings and the like may not represent actual positions, sizes, shapes, ranges, and the like. Thus, the present invention is not necessarily limited to the position, size, shape, range, and the like disclosed in the drawings and the like.

In the following description, various types of information may be described using expressions such as “table”, “list”, and “queue”. However, various types of information may be expressed by other data structures. To indicate that the information does not depend on the data structure, “XX table”, “XX list”, etc. may be referred to as “XX information”. Identifying information may be described using expressions such as “identifying information”, “identifier”, “name”, “ID”, and “number”. These can be interchangeably used.

When there are a plurality of components having the same or similar functions, such components may be described while being denoted with the same reference numerals and different suffixes. When such plurality of components need not to be distinguished from each other, the suffixes may be omitted in the description thereof.

Furthermore, in the following descriptions, processing such that a program is executed may be described, where the object for such processing is variously provided. In some cases, a program is executed mainly with a processor (e.g., CPU or GPU), and a storage resource (e.g., memory) and/or an interface device (e.g., a communication port) may be used as appropriate. Similarly, the object for the processing where a program is executed may be placed on a controller, a device, a system, a computer, or a node including a processor. Alternatively, a dedicated circuit (e.g., an FPGA or an ASIC) for executing specific processing may be included in the object for the processing where a program is executed.

The program may be installed on a device such as a computer from a program source. The program source may be, for example, a program distribution server or a computer-readable storage medium. When the program source is a program distribution server, the program distribution server may include a processor and a storage resource for storing the program to be distributed, and the processor of the program distribution server may distribute the subject program to another computer. In the following descriptions, two or more programs may be implemented as a single program, or a single program may be implemented as two or more programs.

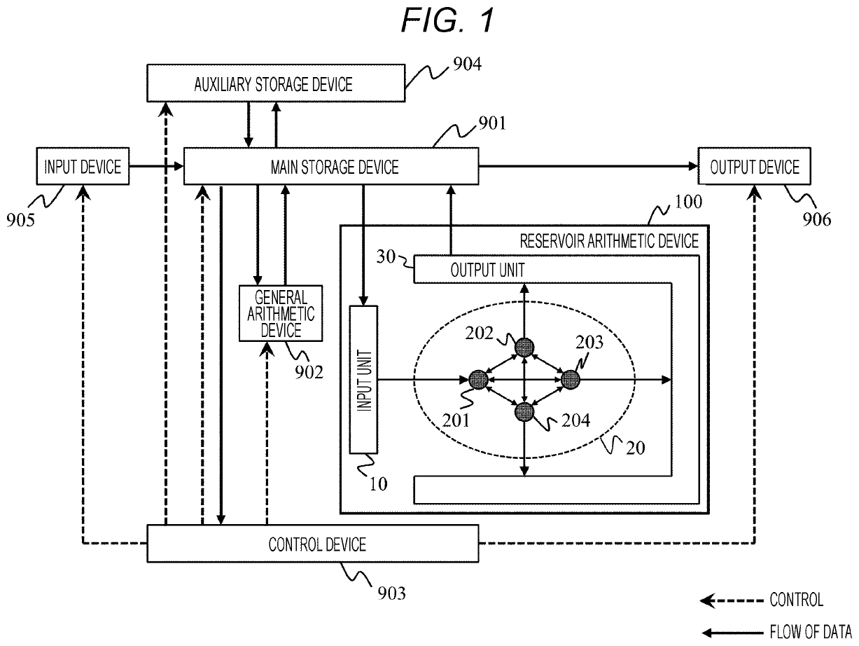

Hereinafter, embodiments of the present invention will be described with reference to FIGS. 1 to 10.

### First Embodiment

Hereinafter, a first embodiment will be described with reference to FIGS. 1 to 4.

A machine learning device according to the first embodiment uses reservoir computing as a basic feature.

First of all, a configuration of the machine learning device according to the first embodiment will be described with reference to FIG. 1.

The machine learning device according to the first embodiment has substantially the same configuration as an ordinary computer, but differs from an ordinary computer in that a reservoir arithmetic device 100 as a machine learning arithmetic device is provided in addition to a general arithmetic device 902. A calculation procedure is almost the same as that in an ordinary computer. Specifically, the procedure is implemented by exchanging data between a main storage device 901 and the general arithmetic device 902 and between the main storage device 901 and the reservoir arithmetic device 100 under the control of a control device 903.

Work data and an execution program are loaded into the main storage device 901, to be referred to from the control device 903 and the general arithmetic device 902. An auxiliary storage device 904 is a nonvolatile large-capacity storage device such as a hard disk drive (HDD) or a solid state drive (SSD), and an execution program and data installed therein are loaded into the main storage device 901 as necessary. Data input to the main storage device 901 is performed through an input device 905, and data output from the main storage device 901 is performed through an output device 906. These operations are performed under the control of the control device 903.

The reservoir arithmetic device 100 is a dedicated calculation unit that is dedicated for supervised learning based on reservoir computing. The reservoir arithmetic device 100 includes a reservoir 20, an input unit 10, and an output unit 30. The reservoir 20 is a body including multiple interacting nodes 201 to 204 and an input/output system.

Next, an operation of the machine learning device will be described with reference to FIGS. 1 to 4.

First of all, an operation performed by the machine learning device will be described.

It is assumed that (xᵥ,yᵥ⁰) is input as training data. Here, the subscript v indicates that xᵥ and yᵥ⁰ are vectors, and components of these are represented as xᵥ=(x₁, x₂, . . . , xₙₓ)^{T} and yᵥ⁰=(y₁⁰, y₂⁰, . . . , y_{ny}⁰)^{T}. Here, xᵥ and yᵥ⁰ are vertical vectors, and T represents transposition. Furthermore, xᵥ is referred to as the first training data and yᵥ⁰ is referred to as the second training data. The main storage device 901 stores (xᵥ,yᵥ⁰) input through the input device 905.

The first training data xᵥ is input to the node 201, through the input unit 10 in the reservoir arithmetic device 100, in the order of x₁, x₂, . . . , xₙₓ. The subscripts of these represent time points. In FIG. 1, arrows represent interaction among the nodes 201 to 204. In ordinary machine learning, arrows are unidirectional, meaning that the direction of action between nodes is fixed. Meanwhile, in physical systems, a model with bidirectional arrows is provided owing to interaction. Still, the function of the machine learning device according to the present embodiment also works in the case of unidirectional arrows. Although the reservoir 20 in FIG. 1 is described with four nodes, the number of nodes may be more than that if more nodes can be incorporated. In general, the performance of the reservoir arithmetic device 100 increases as the number of nodes increases. Which of the nodes interact with each other, as well as the size of the interaction can be set as desired.

In the example of the nodes of the reservoir 20 illustrated in FIG. 1, the first training data xᵥ input to the node 201 time-evolves in accordance with the dynamics of the node 201 itself, the dynamics based on the interaction among the nodes 201 to 204, and the dynamics of the nodes other than the node 201. If the reservoir arithmetic device 100 is a general-purpose arithmetic device such as a general arithmetic device 902, the nodes themselves have no dynamics and only give an input/output relation. If the nodes are formed of a physical system such as a spin system, the nodes themselves have dynamics. This is why rich dynamics can be achieved by applying a physical system to the reservoir.

Let zᵢ(tₖ) be measurement outcome at a node i (i is a subscript corresponding to the node 202, the node 203, and the node 204) at a certain time point tₖ. This zᵢ(tₖ) is a value obtained by measuring a physical quantity at a node and converting it into voltage or current. Through the output unit 30, zᵢ(tₖ) is transmitted to and stored in the main storage device 901. Thus, the measurement outcome zᵢ(tₖ) is obtained.

Next, a training process and a subsequent inference process using unknown input data will be described.

First of all, the training process and the inference process in a case where each measurement outcome is used once will be described. These are general training and inference processes in ordinary machine learning.

An output at the time point tₖ is assumed to be given by using a coefficient wᵢ to be y(tₖ)=Σᵢzᵢ(tₖ)wᵢ. In the training according to supervised learning, wᵢ is determined so that yᵥ=(y(t₂), y(t₂), . . . , y(t_{ny}))^{T} coincides with yᵥ⁰. Specifically, wᵢ minimizing Σₖ(y(tₖ)−y⁰(tₖ))² should be found.

Let wᵥ be a vertical vector whose component is wᵢ, and let Z be a matrix whose (k,i) matrix element is zᵢ(tₖ). Then, yᵥ=Zwᵥ. If there exists wᵥ=wᵥ⁰ resulting in output yᵥ⁰, then yᵥ⁰=Zwᵥ⁰. Since Z is generally not a square matrix, it has no inverse matrix generally, but a pseudo-inverse matrix (Moore-Penrose pseudo-inverse matrix) can be defined. Assuming that Z is m×n matrix, rank(Z)=n, and Z⁺ is the pseudo inverse matrix for Z, the pseudo inverse matrix is Z⁺=(Z^{T}Z)⁻¹Z^{T}. Here, (Z^{T}Z)⁻¹ is the inverse matrix of Z^{T}Z. Using the pseudo inverse matrix Z⁺, wᵥ⁰=Z⁺yᵥ⁰ holds, whereby wᵥ⁰ is obtained. This wᵥ⁰ obtained corresponds to wᵥ achieving the minimum value of Σₖ(y(tₖ)−y⁰(tₖ)².

The calculation described above is implemented with the main storage device 901 and the general arithmetic device 902 exchanging data, and wᵥ⁰ obtained in the end is stored in the main storage device 901.

The above training can be summarized as a process of “determining the coefficient wᵥ⁰ to reproduce the second training data yᵥ⁰”. In the process to reproduce the second training data yᵥ⁰ from the measurement outcome (output value) zᵢ(tₖ) at the node i (i is an subscript corresponding to the node 202, the node 203, and the node 204), the measurement outcome zᵢ(tₖ) is the object processed. Thus, the process of determining the coefficient wᵥ⁰ can be regarded as a process of determining a rule for processing the measurement outcome zᵢ(tₖ). Furthermore, the successful determination of the coefficient wᵥ⁰ means the successful determination of the rule for processing the measurement outcome zᵢ(tₖ) for reproducing the second training data yᵥ⁰.

After the training, an output signal can be inferred from an input data xᵥ^{s} using wᵥ⁰ obtained, to obtain yᵥ^{s}. That is, xᵥ^{s} is transmitted to the node 201 through the input unit 10; zᵢ^{s}(tₖ) is transmitted to the main storage device 901 through the output unit 30 to be stored therein as a result of the time evolution of xᵥ^{s} in accordance with the dynamics of the node 201 itself, the dynamics based on the interaction among the nodes 201 to 204, and the dynamics of the nodes other than the node 201. Using this zᵢ^{s}(tₖ) i.e., using Z^{s}, yᵥ^{s} is obtained by the relation yᵥ^{s}=Z^{s}wᵥ⁰.

This inference process can be summarized as follows: “general input data xᵥ^{s} is arithmetically processed in the reservoir arithmetic device 100, and the arithmetic result is processed based on the rule obtained in the training to obtain an output”.

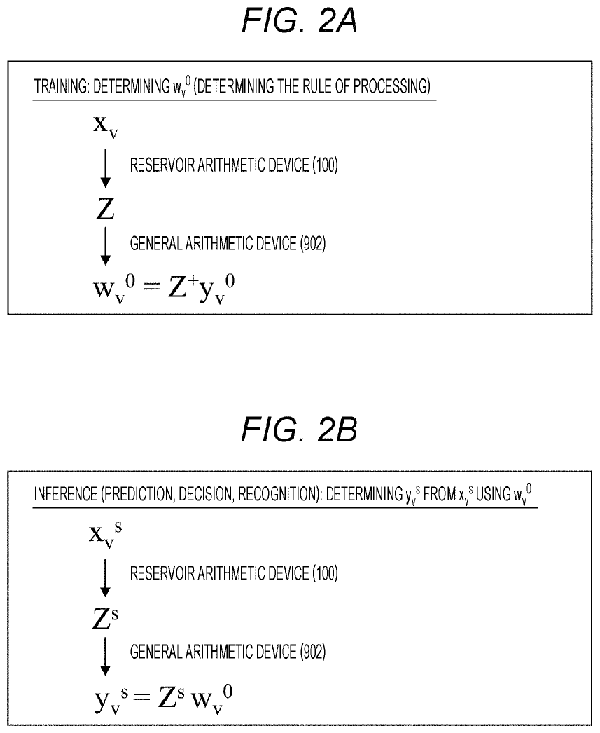

FIGS. 2A and 2B are schematic views each illustrating a summary of the processing described above. The above-described inference can be regarded as prediction, and can also be regarded as decision or recognition depending on the task.

As illustrated in FIG. 2A, in the training process, first of all, the input data xᵥ is input; the reservoir arithmetic device 100 generates a matrix Z whose (k,i) matrix element is zᵢ(tₖ); and wᵥ⁰ is determined at the general arithmetic device 902.

Next, in the inference (prediction, decision, recognition) process, xᵥ^{s} is input to the reservoir arithmetic device 100, and zᵢ^{s}(tₖ) is output. Then, the general arithmetic device 902 uses Z^{s} whose (k,i) matrix element is zᵢ^{s}(tₖ) and wᵥ⁰ obtained in the training process, to determine yᵥ^{s}.

The processing described above corresponds to a conventional technique, where the training process and the inference process use each measurement outcome once. Next, let us describe the extended version of the processing described above, where each measurement outcome is used multiple times in the process of obtaining output data from input data.

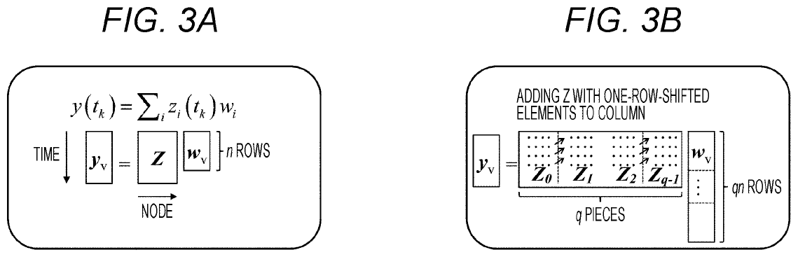

In the case where each measurement outcome is used once, the output at the time point tₖ is calculated as y(tₖ)=Σᵢ₌₁ⁿzᵢ(tₖ)wᵢ as described above. In terms of a matrix and a vector, this is represented as yᵥ=Zwᵥ. This is illustrated in FIG. 3A. This calculation uses zᵢ(tₖ) at the time point tₖ to obtain y(tₖ) at the time point tₖ. However, since the reservoir has a memory effect, zᵢ(t_{k′}) at a time point t_{k′}(k≠k′) can also contribute to the output y(tₖ) at the time point tₖ. In particular, since time evolution of quantum systems occur deterministically based on the Schroedinger equation, zᵢ(t_{j′}) can definitely contribute to y(tₖ). Based on this view, we extend y(tₖ)=(tₖ)wᵢ to y(tₖ)=Σⱼ₌₁^{q}Σᵢ₌₁ⁿzᵢ(tₖⱼ)wᵢⱼ to use the measurement outcome q times (q is an integer that is equal to or larger than 2). This is illustrated in FIG. 3B. The matrix with the elements of Z shifted by one row is added to a side of Z, increasing the number of column. If this process is repeated q times, the column size is increased by q times. This process reuses the matrix elements of Z by shifting them by one row, and therefore, the process uses the same data. Thus, each measurement outcome is repeatedly used as training data q times, as variables in the terms of a linear sum. Here, the maximum value of q is [m/n], where [X] denotes the largest integer not exceeding X, i.e., Gauss symbol. Note that the one-row shift can be made in a forward time direction or in a backward time direction. Alternatively, a combination of both directions may be employed.

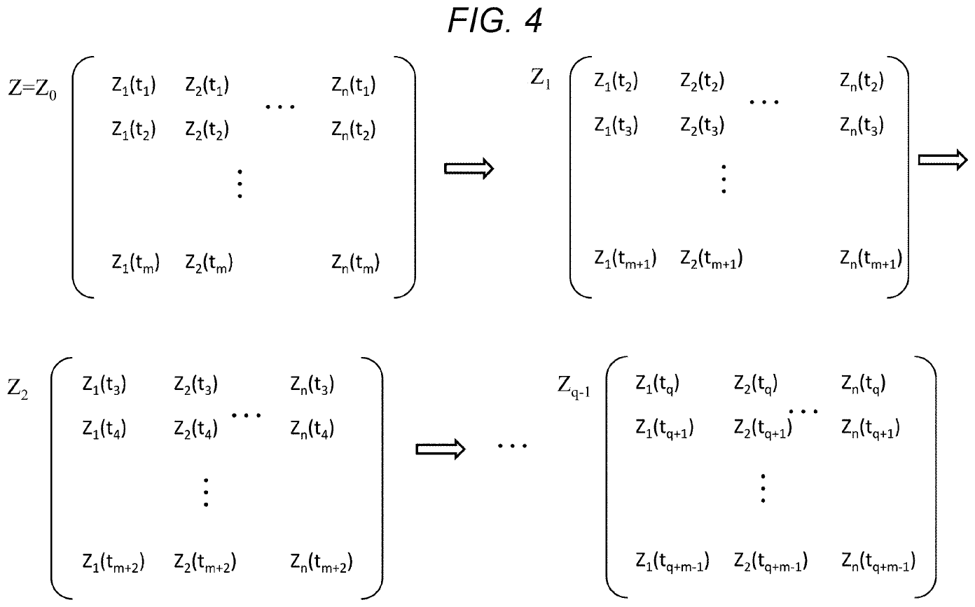

Let Zᵣ be the matrix with the elements of Z shifted by r rows (r=0, . . . , q−1); Z₀=Z. FIG. 4 illustrates Z₀, Z₁, . . . , and Z_{q-1}.

When each measurement outcome is used once, the sum with respect to i is from i=1 to i=n. This means that the size of the vector wᵥ is n. As can be clearly seen in FIG. 3B, when each measurement outcome is used q times, the size of the vector wᵥ is qn. The differences between FIG. 3B and FIG. 3A are only the size of Z and vector wᵥ, meaning that there is no change in the form of yᵥ=Zwᵥ. Thus, the formula y(tₖ)=Σⱼ₌₁^{q}Σᵢ₌₁ⁿzᵢ(tₖⱼ)wᵢⱼ can be simplified with the subscripts i and j being unified. Specifically, the sum range of i is set as i=1 to i=qn, and the subscripts i and j in zᵢ(tₖⱼ) are also unified. This results in an expression y(tₖ)=Σᵢ₌₁^{qn}zᵢ(tₖ)wᵢ. The form of the equation is the same as that in the case where each measurement outcome is used once, although the sum range with respect to i is changed. Thus, even when a measurement outcome is used multiple times, the data processing itself can be the same as that in the case where each measurement outcome is used once. That is, the processing illustrated in FIGS. 2A and 2B executed with the machine learning device can be implemented in the same manner for both cases of using a measurement outcome multiple times and using it once, with only a change in the sizes of Z, wᵥ⁰, and Σₛ and the like.

Thus, the machine learning device according to the first embodiment is the same as the conventional technique in regard that wᵥ⁰ is determined to reproduce the second training data in the training process and the output is inferred from unknown input data using the wᵥ⁰, but is different therefrom in regard that the measurement signal zᵢ(tₖ) at the node i at the time point tₖ obtained through the output unit 30 is redundantly used to draw out the dynamics of the reservoir arithmetic device 100 as much as possible.

As described above, in the present embodiment, the output (measurement outcome) from the machine learning device is redundantly used so that the number of processed data can be expanded to be larger than the number of measurement outcomes. Thus, the dynamics of the machine learning unit can be sufficiently exploited even with a small number of measurement times.

### Second Embodiment

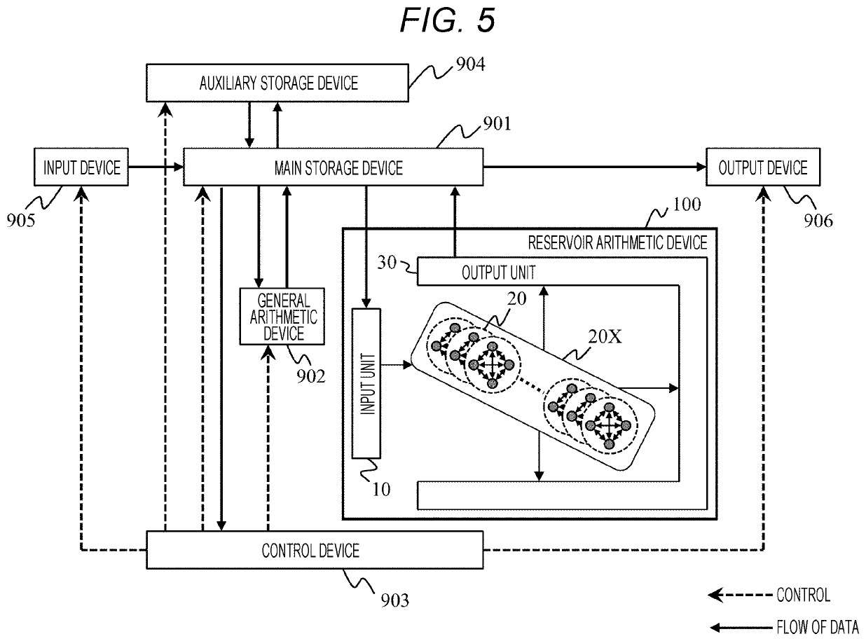

A machine learning device according to a second embodiment is described below with reference to FIG. 5.

The machine learning device according to the present embodiment has substantially the same configuration as the machine learning device according to the first embodiment, and the concept of the training and inference processes are also the same between the two embodiments.

The present embodiment is different from the first embodiment in the configuration of the reservoir arithmetic device 100. In the reservoir arithmetic device 100 according to the first embodiment, the reservoir 20 is a single reservoir. In contrast, the reservoir arithmetic device 100 illustrated in FIG. 5 includes a reservoir 20X including multiple reservoirs 20. This configuration is suitable for a quantum reservoir comprised of a quantum system. Measurement for each node is performed across all the multiple reservoirs 20, and a measurement outcome is given with an average-value measurement for a node that is defined across the multiple reservoirs; then, we are freed from the probabilistic property of quantum mechanical measurements.

### Third Embodiment

A machine learning device according to a third embodiment is described below.

In the first embodiment, a description is given on the processing by the machine learning device that repeatedly uses the measurement outcomes. This is for responding to the situation that the number of measurement times is reduced.

Application of a physical system to the reservoir arithmetic device 100 may encounter various limitations. The number of measurement times is represented by the product of the number of measurement nodes and a measurement frequency. In physical systems, some cases may limit the number of nodes where measurement is possible, and other cases may limit the measurement frequency. In some cases, the number of nodes where measurement is possible is strongly limited (the number of nodes cannot be made large), but the measurement frequency is not so limited. In such a case, it is effective to reduce the number of measurement nodes and increase the measurement frequency.

In the first embodiment, a signal is input at time point tₖ, and measurement (output from a node) is also performed at each time point tₖ. This means that the input frequency and the measurement frequency are the same. When the measurement frequency is increased so that the measurement is performed M times within δ=tₖ₊₁−tₖ (a time period between the time point tₖ and a time point tₖ₊₁) it will be equivalent to increasing the number of measurement nodes by M times. Also considering that the measurement outcome is used q times, the output y(tₖ) at the time point tₖ is expressed by an expression y(tₖ)=Σᵢ₌₁^{qnM}zᵢ(tₖ)wᵢ.

As described, the number of measurement nodes and the measurement frequency can be changed in accordance with the characteristics of the system. Actual values may be determined based on the constraint conditions of each system.

### Fourth Embodiment

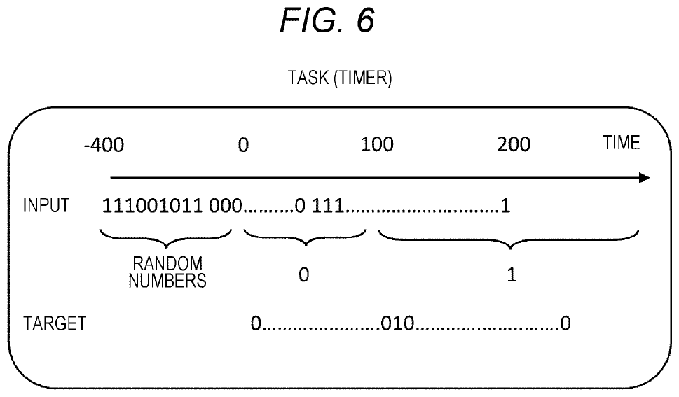

A machine learning device according to a fourth embodiment is described below with reference to FIGS. 6 to 8.

In the first to the third embodiments, the operation principle of the present invention is described using reservoir computing as an example. In the present embodiment, an idea of the invention will be described using a specific calculation result. It is assumed that a quantum system (Ising model) is used for the reservoir arithmetic device 100, and the result of a computer simulation performed under such a condition is used. The Ising model was developed as a physical model in statistical mechanics. Each position (node) can take only two states, and only the interaction between two nodes will be taken into consideration.

In the present embodiment, there are four nodes as in the model of FIG. 1 (FIG. 5), an input is given to the node 201, and measurement outcomes (quantum mechanical expectation values) of three nodes 202, 203, and 204 are output. Interaction between nodes is determined with random numbers.

The task is a timer task as illustrated in FIG. 6. The input signal is a random number of 0 or 1 between t=−400 and t=−1, is 0 between t=0 and t=99, and is 1 at and after t=100. That is, the input signal is a step function at t=100, and is a signal that has a meaning only for t 0. The reason why random inputs are used for t<0 is because an appropriate operation is required regardless of the initial state of the reservoir.

According to the notation in the first embodiment, x(tₖ)=0 for 0≤tₖ≤99, and x(tₖ)=1 for 100 tₖ.

The output value y° (tₖ) of the training data is set as y⁰(tᵢ)=1 at an arbitrary certain time point tᵢ and is set as y⁰(tₖ)=0 at other time points tₖ(≠tᵢ). That is, the output is a pulse at an arbitrary time point tᵢ.

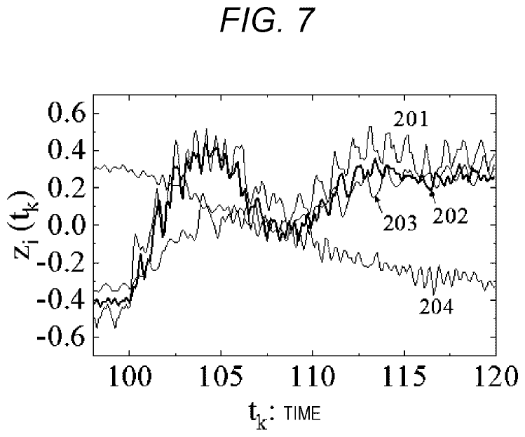

FIG. 7 plots outputs (measurement outcomes) zᵢ(tₖ) from the nodes 202, 203, and 204 in response to unknown input data xᵥ^{s} input to the node 201. In FIG. 7, only a range of time points 98≤tₖ≤120 is shown. The measurement interval is 1/10 of the input interval, meaning that 10 outputs (measurement outcomes) are made for each input. Since the number of nodes of the reservoir arithmetic device 100 coupled to the output unit 30 is three and 10 measurement outcomes are obtained at each node for one input, a total of 30 measurement outcomes are obtained with one input.

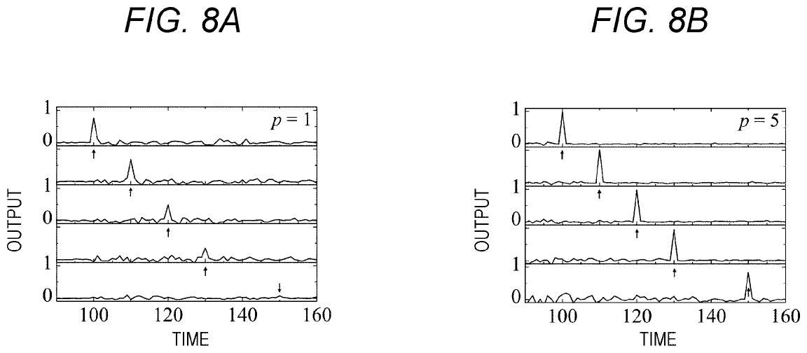

When the value of zᵢ(tₖ) is used in a range of 0≤k≤299 under the condition that the measurement outcome is used only once, Z is a 300×30 matrix. The pseudo inverse matrix Z⁺ is derived and wᵥ⁰=Z⁺yᵥ⁰ is calculated; then the training is completed. FIG. 8A shows the result of inferring yᵥ^{s} from a new input signal xᵥ^{s} using this wᵥ⁰. Peaks appear at the positions corresponding to those of the training data yᵥ⁰. The arrows indicate the positions of the target pulse.

Owing to the forgetting effect of the reservoir arithmetic device 100, the peak height decreases as the pulse position proceeds from t=100 to t=150. In this simulation, relaxation time τ was set to τ=30. Actually, in FIG. 8A, the peak is considerably small at t=130, and it is almost unidentifiable at t=150.

Next, FIG. 8B shows a result of repeatedly using the measurement outcomes five times according to the idea of the present invention. In this case, Z is a 300×150 matrix. By calculating the pseudo inverse matrix Z⁺ and wᵥ⁰=Z⁺yᵥ⁰ and inferring yᵥ^{s} from the input signal xᵥ^{s} in accordance with the procedure illustrated in FIG. 2B, we obtained FIG. 8B. In FIG. 8B, a peak is clearly seen even at t=150.

FIGS. 8A and 8B were obtained using the same data in the training and inference processes. The only difference is whether the measurement outcomes at the nodes are used only once or five times in the inference process. Nevertheless, the inference results are largely different between FIGS. 8A and 8B when time sufficiently progresses. The difference is the effect of the present invention.

The reason why the output signals became clearly identifiable (the peaks in FIGS. 8A and 8B) by using measurement outcomes multiple times is interpreted as a result of some sort of an interference effect where peaks constructively interfere and the quantities corresponding to noise cancel.

The calculation of the present invention is performed by the general arithmetic device 902 and the reservoir arithmetic device 100 (machine learning arithmetic device) as described in the first embodiment. One point in this context is that the versatility is not required for the machine learning arithmetic device. For this reason, a system without versatility but with a special performance can be used for the machine learning arithmetic device. As an example of this, a quantum system is described in the present embodiment. Special systems, such as quantum systems, may involve many limitations, and preferably the number of measurement times should be reduced as much as possible. As a solution to this, the measurement outcomes are used multiple times in the inference process of the machine learning device of the present invention. The machine learning arithmetic device is engaged only in obtaining the measurement outcomes; it is the general arithmetic device 902 that uses the measurement outcomes multiple times. That is, the general arithmetic device 902 and the machine learning arithmetic device are separately in charge of part of calculations; the former is engaged in the calculation requiring high versatility and the latter is engaged in the calculation not requiring versatility but preferably being performed with rich dynamics. Thus, one aspect of the present invention is that it succeeded in letting each arithmetic device dedicate itself to what they are good at.

Another possible aspect is as follows.

In recurrent neural network (RNN) and reservoir computing, an outcome at a node at a time point is reflected on an outcome at the node at a different time point. These methods and the present invention have similarities in the viewpoint of utilizing values at different time points. However, the present invention is clearly different from these methods. Specifically, while the approach used in general RNN and reservoir is related to a concept inside the RNN and the reservoir, the approach according to the present invention is related to the concept outside the RNN or reservoir. The approach used in general RNN and reservoir improves the dynamics through temporally connecting values at respective nodes inside a time sequence. In contrast, the approach according to the present invention effectively extracts the dynamics that are obtainable through the general approaches for RNNs and reservoirs; the aim is different. In order to maximize the performance of the system, means for generating dynamics and means for drawing the dynamics out are both required. The method of the present invention achieves the latter, so that both of these means can be provided.

Furthermore, while the time sequence in the RNN or reservoir flows only in one direction from the previous time point to the subsequent time point, the time sequence in accordance with the present invention may be in either direction. This is another major difference between the two concepts.

In the fourth embodiment, an example of the execution of a timer task was described as the most easily understandable example. Alternatively, the present invention can be applied to wide variety of tasks such as voice recognition.

### Fifth Embodiment

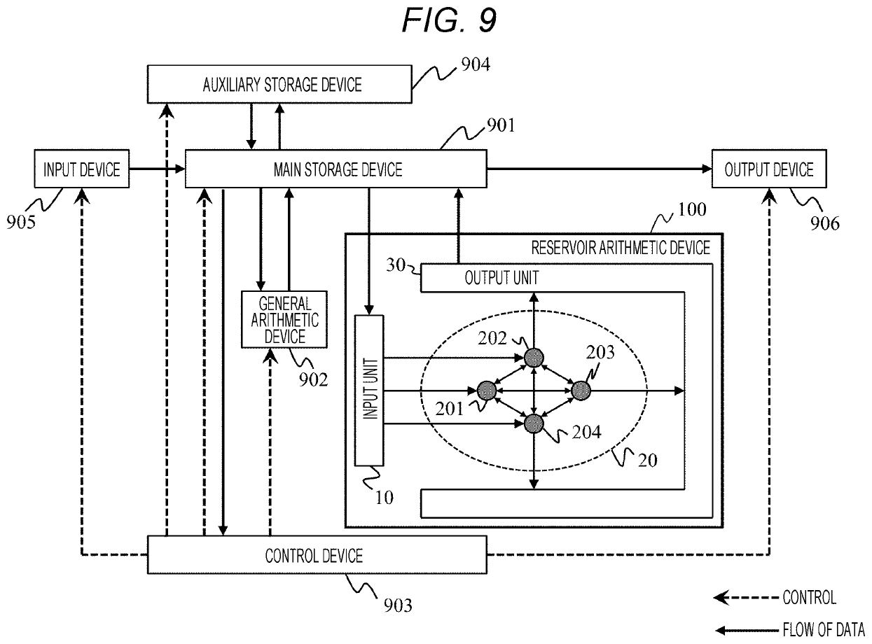

A machine learning device according to a fifth embodiment is described below with reference to FIG. 9.

In the first to the fourth embodiments, one input x(tₖ) and one output y(tₖ) are assumed at the time point tₖ. Alternatively, both input and output can be more than one as illustrated in FIG. 9. According to a configuration of the machine learning device illustrated in FIG. 9, inputs are sent to the nodes 201, 202, and 203, and outputs are took out from the nodes 202, 203, and 204. Specifically, inputs at the time point tₖ are xₚ(tₖ) (where p is a subscript corresponding to the node 201, the node 202, and the node 204), and outputs are yⱼ(tₖ) (where j is a subscript corresponding to the node 202, the node 203, and the node 204). Accordingly, the formula for the output is given by yⱼ(tₖ)=Σᵢzᵢ(tₖ)wᵢⱼ, with the subscript j. Only the difference is the addition of the subscripts p and j, and thus, the methods according to the first to the fourth embodiments can be directly usable.

### Sixth Embodiment

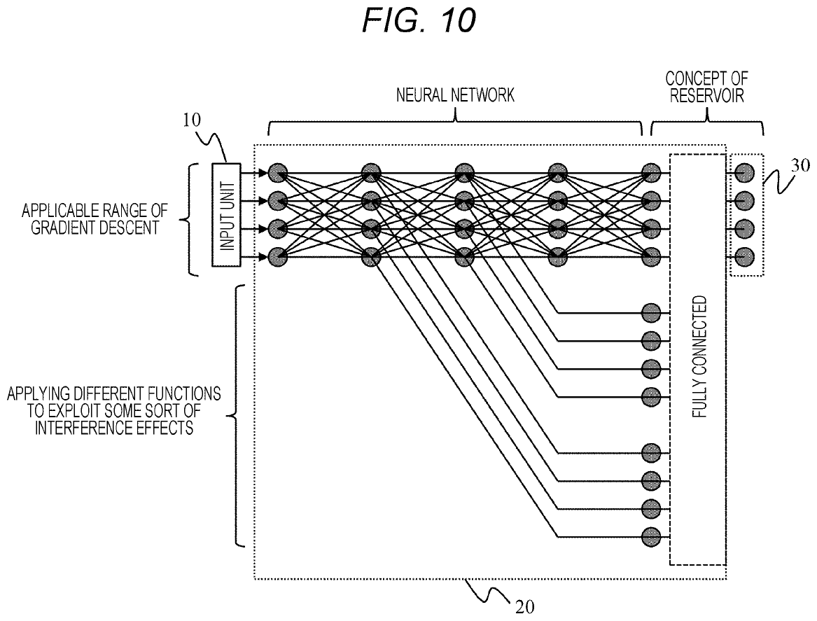

A machine learning device according to a sixth embodiment is described below with reference to FIG. 10.

In the first to the fifth embodiments, the embodiments of the present invention are described using reservoir computing as an example. Alternatively, the present invention can be applied to other types of machine learning. In the present embodiment, an example in which the present invention is applied to deep learning will be described.

In a machine learning model illustrated in FIG. 10, multilayered nodes for deep learning are provided in the portion corresponding to the reservoir 20 in FIG. 1. As described above, the feature of the present invention lies in that the measurement outcome zᵢ(t_{k′}) at the node i at the time point t_{k′}(k≠k′) also contributes to the output y(tₖ) at the time point tₖ. In accordance with the idea, as illustrated in FIG. 10, measured information at the previous layers, viewed from the output side, is added into the connections in the reservoir. This means that the methodology described in the first to the fifth embodiments is applied to deep learning. It can also be regarded that the concept of reservoir is added to the concept of neural network. Here, let us limit the application range of the gradient descent and the like generally needed in deep learning to, for example, the range illustrated in FIG. 10. Because the range is limited, the amount of calculation required in the training stage can be made smaller than that in case of ordinary deep learning. It is also effective to change a function (action at the edges between nodes) at nodes when adding the information from the previous layers to the output, to exploit some sort of interference effect. As in this example, the present invention can be applied to various types of machine learning.

As described above in the embodiments, the present invention can make the number of processing data large even when the number of measurement times at the machine-learning-dedicated device is small. Thus, a large amount of information can be extracted with the small number of measurement times, whereby the dynamics offered with physical systems can be sufficiently drawn out even when measurements accompany difficulties.

What is claimed is:

1. A machine learning device comprising:
a general arithmetic device that calculates data;
a machine learning arithmetic device that performs certain calculation on the data;
a storage device that stores the data; and
a control device that controls the exchange of the data between the storage device and the general arithmetic device and between the storage device and the machine learning arithmetic device, wherein
the machine learning arithmetic device includes:
at least one node;
an input unit; and
an output unit,
the machine learning arithmetic device performs calculation in response to an input value input through the input unit by utilizing the dynamics of the nodes and outputs a result of the calculation as a measurement outcome from the output unit, and
the general arithmetic device uses each measurement outcome multiple times as a variable in the terms of a linear sum to obtain an output value.

2. The machine learning device according to claim 1, wherein
let the number of nodes be n, n being an integer that is equal to or larger than 1,
let zᵢ(tₖ) be the measurement outcome at a node i at a time point tₖ,
let y(tₖ) be the output value at the time point tₖ,
let wᵢ be a coefficient for zᵢ(tₖ) for obtaining the linear sum, determined through learning, then
the output value satisfies a relation y(tₖ)=Σᵢzᵢ(tₖ)wᵢ,
where in addition to the measurement outcome zᵢ(tₖ) at the node i at the time point tₖ, measurement outcome t_{k′}(t_{k′}) at the node i at a time point t_{k′}(k′≠k) is included to represent the output value y(tₖ), thereby zᵢ(tₖ) at different time points is redundantly used, and
let q be the number of the redundancy, q being an integer that is equal to or larger than 2, then
the number of terms in the linear sum representing the output value y(tₖ) is qn.

3. The machine learning device according to claim 2, wherein the value zᵢ(tₖ) at the node i is measured M times within the time period δt=tₖ₊₁−tₖ between the time point tₖ and the time point tₖ₊₁, resulting in the number of terms in the linear sum representing the output value y(tₖ) being qnM.

4. The machine learning device according to claim 1, wherein the nodes are nodes in reservoir.

5. The machine learning device according to claim 1, wherein the nodes are nodes in neural network.

6. The machine learning device according to claim 1, wherein inputs at the time point tₖ are multiple, the multiple inputs being respectively input to a respective node p as an input value xₚ(tₖ).

7. The machine learning device according to claim 2, wherein outputs at the time point tₖ are multiple,
let yⱼ(tₖ) be the output value at the time point tₖ,
let wᵢⱼ be the coefficient of the term zᵢ(tₖ) generating the output value yⱼ(tₖ), then
yⱼ(tₖ)=Σᵢzᵢ(tₖ)wᵢⱼ is satisfied.

8. A machine learning method for a machine learning arithmetic device that comprises:
a general arithmetic device that calculates data;
a machine learning arithmetic device that performs certain calculation on the data;
a storage device that stores the data; and
a control device that controls the exchange of the data between the storage device and the general arithmetic device and between the storage device and the machine learning arithmetic device,
the machine learning arithmetic device including:
at least one node;
an input unit; and
an output unit, the machine learning method comprising:
by the machine learning arithmetic device, performing calculation in response to an input value input through the input unit by utilizing the dynamics of the nodes and outputting a result of the calculation as a measurement outcome from the output unit; and
by the general arithmetic device, using each measurement outcome multiple times as a variable in the terms of a linear sum to perform calculation and outputting a result of the calculation.

9. The machine learning method according to claim 8, wherein
let the number of nodes be n, n being an integer that is equal to or larger than 1,
let zᵢ(tₖ) be the measurement outcome at a node i at a time point tₖ,
let y(tₖ) be the output value at the time point tₖ,
let wᵢ be a coefficient for zᵢ(tₖ) for obtaining the linear sum, determined through learning, then
the output value satisfies a relation y(tₖ)=Σᵢzᵢ(tₖ)wᵢ,
where in addition to the measurement outcome zᵢ(tₖ) at the node i at the time point tₖ, measurement outcome t_{k′}(t_{k′}) at the node i at a time point t_{k′}(k′≠k) is included to represent the output value y(tₖ), thereby zᵢ(tₖ) at different time points is redundantly used, and
let q be the number of the redundancy, q being an integer that is equal to or larger than 2, then
the number of terms in the linear sum representing the output value y(tₖ) is qn.

10. The machine learning method according to claim 9, wherein the value zᵢ(tₖ) at the node i is measured M times within the time period δt=tₖ₊₁−tₖ between the time point tₖ and the time point tₖ₊₁, resulting in the number of terms in the linear sum representing the output value y(tₖ) being qnM.

11. The machine learning method according to claim 8, wherein the nodes are nodes in reservoir.

12. The machine learning method according to claim 8, wherein the nodes are nodes in neural network.

13. The machine learning method according to claim 8, wherein inputs at the time point tₖ are multiple, the multiple inputs being respectively input to a respective node p as an input value xₚ(tₖ).

14. The machine learning method according to claim 9, wherein outputs at the time point tₖ are multiple,
let yⱼ(tₖ) be the output value at the time point tₖ,
let wᵢⱼ be the coefficient of the term zᵢ(tₖ) generating the output value yⱼ(tₖ), then
yⱼ(tₖ)=Σᵢzᵢ(tₖ)wᵢⱼ is satisfied.
